(19) United States
(12) Patent Application Publication
(10) Pub. No.: US 2010/0271456 A1
(43) Pub. Date: Oct. 28, 2010

(54) CONFERENCE DETAILS RECORDING SYSTEM

(75) Inventors: Makoto TSUMURA, Hitachi (JP); Hisashi Hamachi, Yokohama (JP); Yutaka Yamashiki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Future Vision Inc.

(21) Appl. No.: 12/764,547

(22) Filed: Apr. 21, 2010

(30) Foreign Application Priority Data
Apr. 27, 2009 (JP) 2009-107589

(51) Int. Cl. H04N 7/14

(52) U.S. Cl. 348/14.08; 348/E07.077

(57) ABSTRACT

The invention provides a conference details recording system for recording various types of information presented during the course of a conference by associating the contents of the presentation with speakers and with words, phrases, etc. in the presentation together with time information so that any type of information as desired can be retrieved later by using a predetermined retrieval key. The system comprises a conference room 100, an entering and leaving control unit 200 to control entering and leaving of conference participants in the conference room, a display unit 300, an image/voice collecting unit 400, a recording unit 500, an information coordinating unit 600, a superintendence control unit 700, and a clock 800, and information of the conference recorded on the recording unit 500 is retrieved by using keywords or key phrases, etc. inputted via an input/output interface 900.

### FIELD OF THE INVENTION

The present invention relates to a conference details recording system, by which the details of participant's speaking in a conference are recorded in connection with the speakers together with day and time of the presentation and with details of the presentation as subject so that it is possible to identify and retrieve the details of the conference, to specify each of the speakers and the time of the presentation.

In the presentation of the results of the studies performed for technical development, it is important how the results obtained on the technical development are related to laws and regulations and what kind of causal relation exists between them. Also, when engineers and management staffs attend a conference to present the results of the studies, they reply to questions and perform discussions with other participants of the conference with regard to each of the stages of: proposals of original technical ideas, preparation of basic specifications, trial production, manufacture of full-scale product, and patent application, and it is often noted that the detailed contents presented and discussed in the conference may contain important subjects relating to an invention.

It is necessary to clarify the share of common right and to secure the ratio of allocating the resources by confirming the presence of the prior presentation right later and the source of the proposal of ideas in each of the stages. This type of action is also called DR (design review) or DRM (design review meeting).

Currently, a method is generally known, according to which many enterprises, universities, etc. are consolidated together in a single organization, and the details of presentation and the contents of questions and replies in the meetings or discussions sponsored by management staffs of such organization are recorded on paper documents or in electronic documents stored on a recording medium, which can be easily reproduced, or a video recording is prepared by taking the detailed aspects of the conference, and a manager vested with authority and right on these recordings gives authentication and stores the recording. Also, as authenticating means for estimating the ratio of burden of costs and expenditure required for technical development and attribution of right for future reference, there is a method to use a notary office and to confirm the details of authentication by reproducing the contents of the paper documents or the contents of the recording medium as authenticated by the notary office.

As the prior art relating to the method to authenticate the prior art for recording the detailed contents of the conference as an electronic document, the technical details of the invention are disclosed in the Patent Document 1, the Patent Document 2, the Patent Document 3, and the Patent Document 4. Also, the Patent Document 5 discloses a technique to prepare text document from the details of the presentation at the conference. Further, the Patent Document 6 and the Patent Document 7 are known as disclosing a technique relating to an electronic board as display, which is described in the embodiment of the present invention.

### PRIOR TECHNICAL REFERENCES

[Patent Document 1] JP-A-2004-208188

[Patent Document 2] JP-A-2002-271498

[Patent Document 3] JP-A-2002-251393

[Patent Document 4] JP-A-8-316953

[Patent Document 5] JP-A-2005-277462

[Patent Document 6] JP-A-2002-142054

[Patent Document 7] JP-A-2007-220341

### SUMMARY OF THE INVENTION

The detailed contents as presented in the conferences, for which questions and relies are given and discussions are made, generally include: figures and tables, structural drawings, drawings of mechanisms, parameters, and/or mathematical formulae. These are visibly displayed on screen of a display such as a white board, or on an electronic display (including the electronic board as given above). Also, there are high possibilities that the changes such as addition, amendment, erasing, etc. may be made as appropriate on the detailed contents of the display. For the purpose of recording various types of information together with time information with the time passing, conventional writing means cannot be applied, and also conventional type sound recording means and image recording means are also not sufficient.

After various types of information as given above have been recorded, it is often wanted to identify the so-called prior speaker (presenter), who had presented the same details first, by means of retrieving the key words or the key phrases, or retrieving the participants. At present, no system is known, by which the information concerned as wanted can be-easily retrieved and reproduced.

It is an object of the present invention to provide a conference details recording system, by which it is possible to record various types of information presented or proposed during the course of a conference by associating with the speakers and with words, terms, and phrases together with time information so that any type of information as desired can be easily retrieved and reproduced from the recorded information by means of a retrieval key.

To attain the above object, the present invention provides a conference details recording system, by which various types of information such as display images presented during the course of a conference, an images of speakers, voices of speakers, etc. are recorded as electronic information by associating with personal authentication information of the speakers together with time information so that the recorded electronic data on a type of information as desired can be easily acquired by means of a retrieval key.

The conference details recording system according to the present invention is provided with various types of means for accomplishing the object of the invention in the conference room. In these means, a display for displaying various types of information such as documents, drawings, and mathematical formulae relating to the subject of the conference as images and for offering the information to all of the participants of the conference is included as an important element. To this display, means to read the image information displayed on the display screen regularly or arbitrarily at any time desired and at a predetermined time together with time information is provided as functional means, or the means having such function is separately provided.

This recording system includes the means, which is used to collect the contents of presentation (voice information) of the speakers in questions and answers, to its image information of the contents of presentation by speakers, who offer the presentation on the subject of the conference, and to record these types of information together with time information. Further, information coordinating means is also included, which is used to identify the speakers and to associate time information with voice information and image information. The program director of the conference is also included in the speakers.

The conference room, which constitutes the system of the present invention, is provided with entering and leaving control means for controlling the entering and the leaving of the participants of the conference. This entering and leaving control means identifies each participants who enters or leaves the conference room, confirms behavior of the participants during the course of the conference including entering and leaving to and from the conference room during the course of the conference and after the termination of the conference together with time information and records. The entering and leaving information thus recorded is used for identification of the speakers in the conference and as one of the types of key information in this record. In the explanation as given below, this “means” is described as “unit”.

Detailed description will be given on an arrangement of the conference details recording system according to the present invention. The conference details recording system comprises a conference room as described above, an entering and leaving control unit, a display, a voice information collecting unit and an image information collecting unit, a recording unit, an information coordinating unit, a clock, and a superintendence control unit. The recording unit stores various types of information picked up at the voice information collecting unit and the image information collecting unit, and also stores coordinating information prepared by the coordinating unit.

Various types of information recorded in the recording unit can be retrieved later by using the information required as a key for retrieval.

According to this system, various types of information presented during the course of the conference in the conference room can be recorded completely and can be reproduced by retrieving by means of a key as necessary, and the details of the conference can be reproduced through identification of the speakers, identification of key information, identification of time, etc. Because the details of the conference can be reproduced with the time passing through identification of the speakers, the so-called prior speaker can be easily identified, and it is possible to specify each speaker by means of retrieving the key words or the key phrases, or retrieving the participants.

### BRIEF DESCRIPTION OF THE DRAWINGS

FIG. 1 is a functional block diagram to explain an overall arrangement of a conference details recording system according to the present invention;

FIG. 2 is a drawing to show general concept of an arrangement example of a conference room in the invention;

FIG. 3 is a functional block diagram to explain an arrangement example of an entering and leaving control unit in a conference room according to the invention;

FIG. 3A is a functional block diagram to explain an example of an entering and leaving detection device, which constitutes the entering and leaving control unit;

FIG. 3B is a flowchart to explain an example of an entering and leaving detection operation prior to the starting of the conference in the entering and leaving control unit;

FIG. 3C is a flowchart to explain an example of an entering and leaving detecting operation after the starting of the conference in the entering and leaving control unit;

FIG. 4 represents functional diagrams of arrangement examples, each to explain an arrangement of a display unit in the conference room according to the invention;

FIG. 4A is a schematical drawing to explain a concrete example of the display unit;

FIG. 4B is a drawing to explain a concrete example of a display element of the display unit;

FIG. 4C is a flowchart to explain an example of reading and recording operation on the details of conference displayed on the display unit;

FIG. 5 represents functional block diagrams, each to explain an arrangement example of an image/voice collecting unit of the invention;

FIG. 5A is a drawing to explain an arrangement example of a speaker image collecting unit, which constitutes the image/voice collecting unit;

FIG. 5B is a drawing to explain an arrangement example of a speaker voice collecting unit, which constitutes the Image/voice collecting unit;

FIG. 6 represents a functional block diagram to explain an arrangement example of a recording unit in the invention;

FIG. 7 represents functional block diagrams, each to explain an arrangement example of an information coordinating unit of the invention;

FIG. 7A is a functional block diagram to explain an arrangement example of a voice/key information extracting unit in the information coordinating unit;

FIG. 7B is a block diagram to explain an example of processing of an information associating device in the information coordinating unit; and

FIG. 8 represents a flowchart to explain an example of procedure to retrieve conference information recorded in the recording unit.

### DESCRIPTION OF THE PREFERRED EMBODIMENTS

According to the system of the present invention, various types of useful information as offered in a conference and data on the speakers in the conference are associated and coordinated in words, phrases, etc. given in the words in the presentation by the speakers or shown in the Images on display, and these data are recorded together with time information so that any type of information as desired can be reproduced from the recorded information by means of a retrieval key as appropriate.

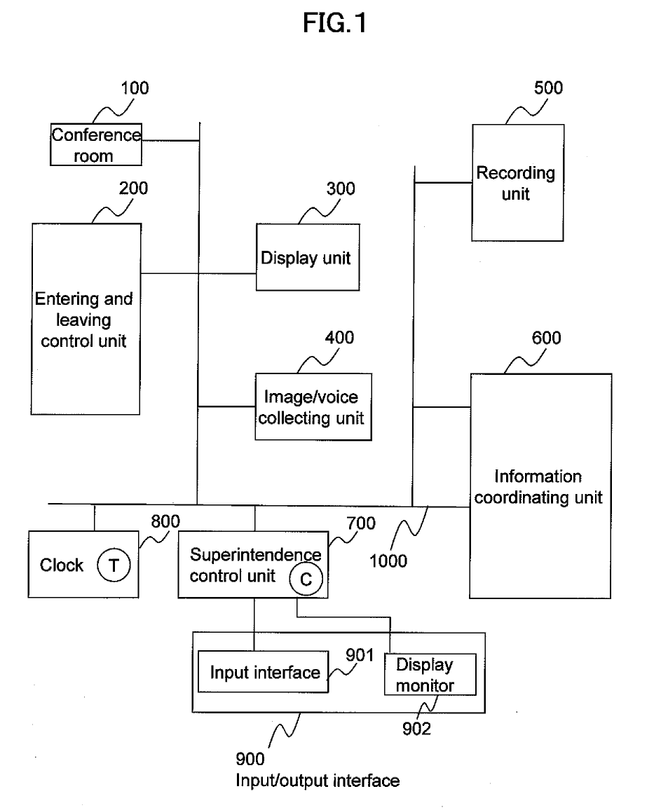

FIG. 1 is a functional block diagram to explain overall arrangement of a conference details recording system according to the present invention. The conference details recording system of this embodiment comprises a conference room 100, an entering and leaving control unit 200 for management of the entering and the leaving of conference participants to and from a conference room, a display unit 300, an image/voice collecting unit 400, a recording unit 500, an information coordinating unit 600, a superintendence control unit 700, and a clock 800. To the superintendence control unit 700, an input/output interface 900 for inputting retrieval conditions in an information retrieval mode as to be described later is connected for the starting of the system, for advance setting (pre-setting) such as the matters relating to bibliography necessary prior to the opening of the conference, and for the setting of basic control conditions. The input-output interface 900 comprises, for instance, an input device 901 including a keyboard and a mouse, and a display monitor 902 for confirming key phrases and retrieval condition and for outputting the result, and the details of the conversation between an operator and the system are recorded.

As the clock 800, a clock provided with control devices or a superintendence control unit (CPU) 700 may be used, or an electric wave correcting clock may be used to correct the time of these types of clocks according to the standard time radio wave signals so that the correctness of date and time can be assured. These component elements are mutually connected to a data bus 1000, and operation is organically carried out to attain the purpose of the invention under the control of the control devices having these component elements and the superintendence control unit 700. Detailed description will be given below on the best mode for carrying out the present invention by referring to the embodiments of the invention.

### Embodiment 1

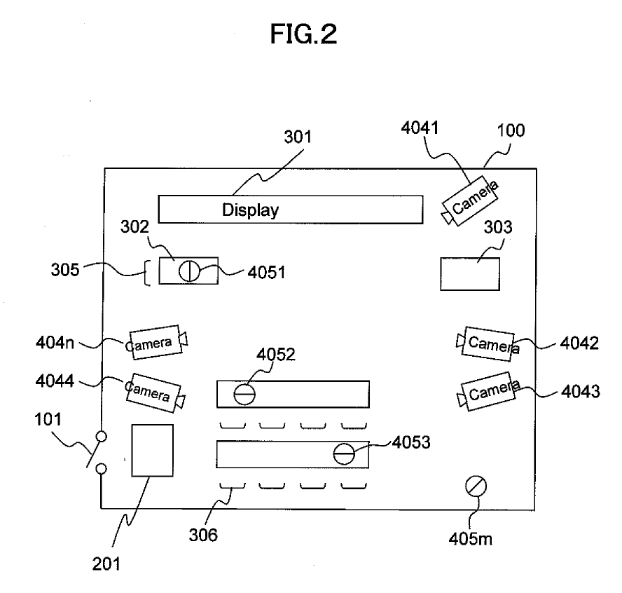

Referring to FIG. 2, description will be given on an arrangement example of the Embodiment 1 of a conference room 100, in which a conference details recording system of the present invention is operated. In FIG. 2, only one door 101 is shown, while there may be two or more doors. However, if consideration is given on the cost of installation of an entering and leaving detection device 201 near the door 101, it is desirable to arrange that entering and leaving to and from the conference room 100 is carried out through one door 101. In FIG. 2, it is shown that the entering and leaving detection device 201 is installed inside the conference room 100, while it is needless to say that it may installed outside the conference room 100.

Inside the conference room 100, there are provided a display 301, and a display writing device 302 for writing information on the display. This display writing device 302 is a device suitable for the functions of the display 301. This will be described later. Further, a display reading device 302 to read various types of information displayed on the display 301 is installed. This display reading device 302 is also a device suitable for the functions of the display 301, and detailed description will be given later.

Further, an image pickup device and a voice pickup device are installed inside the conference room 100. The image pickup device comprises a plurality of cameras 4041-404n, and these cameras are installed to pick up images of the speakers and images of participants of the conference, who enter and leave through the door 101 in the conference room 100. The voice pickup device comprises a plurality of microphones (hereinafter referred as “MIC”) 4051-405m so that words and voices of the speakers can be picked up.

Inside the conference room 100, there are arranged a speaker's seat (platform for speaking) 305 and seats 306 for conference participants. Although it is not shown in the figure, a seat for a person in charge of expediting the conference may be provided.

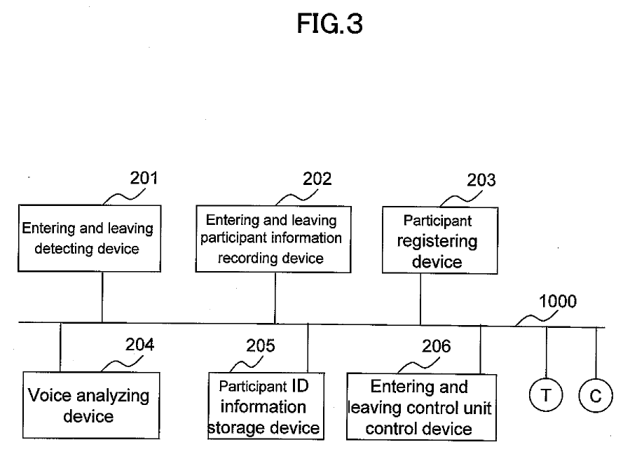

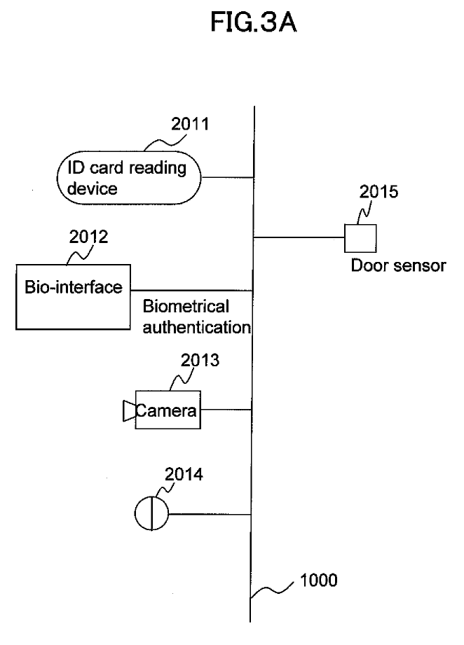

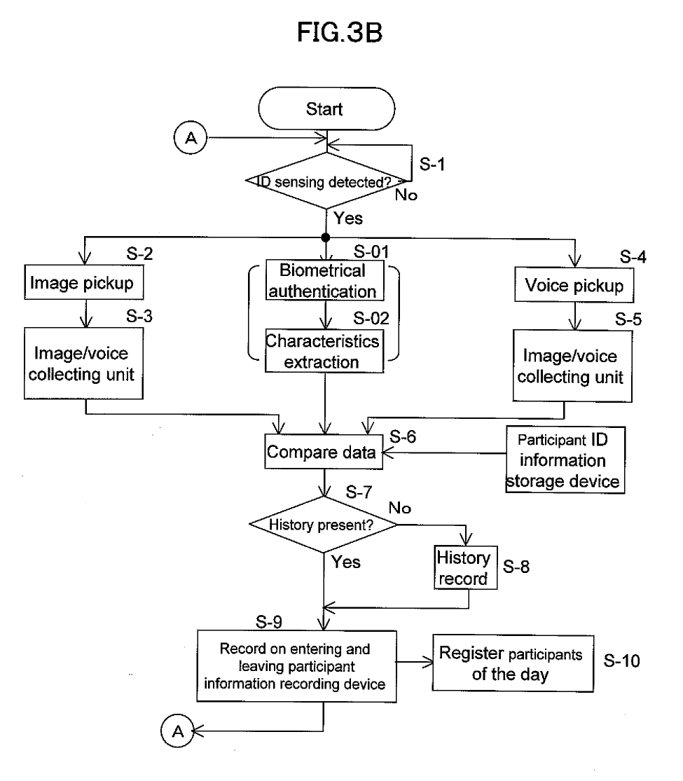

FIG. 3 is a drawing to explain an arrangement example of an entering and leaving control unit, which is to be installed at an entrance/exit of the conference room. This entering and leaving control unit 200 comprises an entering and leaving detection device 201, an entering and leaving attendant information recording device 202, a conference participant registering device 203, a voice analyzer 204, a conference participant ID information storage device 205, and an entering and leaving control means control device 206. The entering and leaving detection unit 201 detects individual information of each of the conference participants who are going to enter the conference room, and also detects other conference participants who enter and leave the conference room subsequently and places data of these conference participants under management.

FIG. 3A shows an arrangement example of the entering and leaving detection device 201. The entering and leaving detection device 201 may be provided with an ID card reading device 2011 for reading storage information on an ID card where a conference participant who is going to enter the conference room has embedded an IC chip, a so-called bio-interface 2012 to carry out biometrical authentication of each participant, a camera 2013 for picking up figures, features, etc. of each participant, and a microphone 2014 for picking up voices of the conference participants. The bio-interface 2012 detects physical characteristics of each person-that is, static characteristics (such as fingerprints, palm form, patterns of retina and iris, etc.) or behavioral characteristics (such as features of handwriting, locus of handwriting, writing speed, writing pressure of handwriting, etc.). As the other behavioral characteristics, a method may be adopted to detect features of movement of lips during speaking, and features of blinking by using the output of the camera 2013.

The bio-interface 2012 as described above is installed when it is used instead of personal authentication by using an ID card. In a conference where special emphasis is placed on the accuracy of authentication, it is desirable to use both of them. Or, there is a method to use only the bio-interface. In the Embodiment 1, it is arranged that each participant is asked to carry an ID card where IC chip is embedded for the detection of personal information (personal authentication) so that personal authentication information stored in the IC chip can be read on non-contact basis.

Also, each conference participant, who is going to enter the conference room, is requested to utter voice on the entering and leaving detection device 201. This can be simply done by reading a predetermined phrase. In case a voice recognizing software of high degree can be used, it may be an oral statement to utter greeting words for the attendance, natural conversation, or to tell the post of assignment, the name, etc. The voice picked up by the microphone is analyzed at the voice analyzer 204. Voice analysis is performed by examining voice spectrum, waveform or voiceprint or a combination of two or more of these. In the Embodiment 1, voice print analysis is adopted. The results of analysis are recorded and converted to digital data and are recorded as a part of each ID information at the conference participant ID information storage device 205.

In the entering and leaving attendant information recording device 202, the entering and leaving attendant information as detected by the entering and leaving detection device 201 is recorded. Conference attendants on a day concerned are registered on the attendant registering device 203, and these data are kept as attendance history information. Time information as acquired from the clock 800 is added to the entering and leaving attendant information as detected by the entering and leaving detection device 201, and this data is recorded on the entering and leaving attendant information recording device 202.

First, FIG. 3B shows a flow of processing to explain one example of the entering and leaving detecting operation before the starting of the conference by the entering and leaving control means. FIG. 3B is to explain operation of the entering and leaving control unit when the door of the conference room is opened prior to the starting of the conference. The condition where the door of the conference room is opened indicates an operating condition where information of opening and closing of door is not the necessary requirements. Therefore, the operations where these are performed in the conference room (i.e. under indoor condition where the door is closed) are also included in the entering and leaving detecting operation.

In FIG. 3B, when a conference participant comes close to an entrance or an exit of the conference room 100, and when the ID card reading device 2011 in FIG. 3A detects it (S-1). Then, the entering and leaving control unit control device 206 makes the microphone 2014 active by the camera 2013, and it is started to pick up an image of a person who is near the ID card reading device 2011 (S-2) and picks up the voice obtained from the conversation with a conference staff (S-4). As a matter of fact, a microphone, which has directivity to this person, is used. To carry out biometrical authentication, the bio-interface is started to carry out biometrical authentication (S-01), and the characteristics of the person are detected (S-02).

The image information picked up by the camera 2013 is transferred to the image/voice collecting unit 400 together with the detected ID information (S-3). Also, voice information taken by the microphone 2014 transferred to the image/voice collecting unit 400 together with the ID information (S-5). The image information and the voice information transferred to the image/voice collecting unit 400 are compared with the participant ID information, which is recorded at the participant ID information storage device 205 (S-6). If no attendance record in the past is found in this comparison procedure (S-7) (judgment “No”), it is recorded as history information at the participant ID information storage device 205 (S-8). In case attendance history in the past is found in the comparison procedure (S-7) (judgment “Yes”), the data is recorded at the entering and leaving participant information recording device 202 (S-9), and the data is registered on the participant registering device 203 as the conference participant of this data (S-10). After recording the data on the entering and leaving participant information recording device 202, it goes back to the processing on the next participant.

Next, referring to FIG. 3C, description will be given on one example of the entering and leaving detecting operation of the entering and leaving control unit after the conference is started. This operation is an operation of the entering and leaving control unit under the condition where the doors of the conference room are closed. It is an operation of the entering and leaving control unit in case of the entering during the course of the conference and in case of leaving during the course of the conference and after the conference is closed.

The system of the present invention monitors opening and closing of the door 101 at all times (S-11). When the conference is started, the door 101 is closed. In case a conference participant must leave the conference room from some reason after the starting of the conference, the participant, who is going to leave the room, comes closer to the door 101 of the conference room 100. The door 101 is opened, and when the ID card reading device 2011 of FIG. 3A detects it (ID detection; S-12), the participant who is going to leave the conference room is identified by comparing with the information recorded on the participant ID information storage device 205 (S-13). Then, it is judged whether the participant to leave the room thus identified has a record of entering the room or not (S-14). Normally, there is a recording of the participant entering the room. Then, it is judged the participant has left the room (S-15), and the withdrawal of the leaving participant is recorded in the entering and leaving participant information recording device 202 (S-17). Then, it is confirmed that the withdrawing participant has left the room and that the door 101 has been closed (S-18). Then, it goes back to the procedure (S-12).

In case of the entering in the course of the conference, the participant entering the room is identified in the procedure (S-13) of FIG. 3C. Then, it is judged whether there is a record of midway withdrawal after the starting of the conference or not. In case there is a midway withdrawal recording after the starting of the conference, permission of entering and leaving is given after the judgment of the entering and leaving (S-15), and it is recorded on the entering and leaving participant information recording device 202 that it is re-entering. This midway withdrawal record will be an alibi of the participant during the time zone concerned. This can be used as the condition to exclude the persons in question in the retrieval of the preceding speaker.

In case an participant coming too late enters the conference room in the course of the conference, there is no record of midway withdrawal in the entering and leaving participant information recording device 202 in (S-14) of FIG. 3C, and the same procedure of the conference participant identification prior to the starting of the conference, or ID information acquisition and recording in FIG. 3B is carried out (S-16). Then, it goes to the procedure of (S-17). By carrying out the procedure as given above, the entering and leaving of the participants of the conference can be accurately identified together with the time. This will be useful as criteria of the contribution on important evaluation matters such as new proposal by individual participant when the information including the details of the conference as recorded is to be re-used.

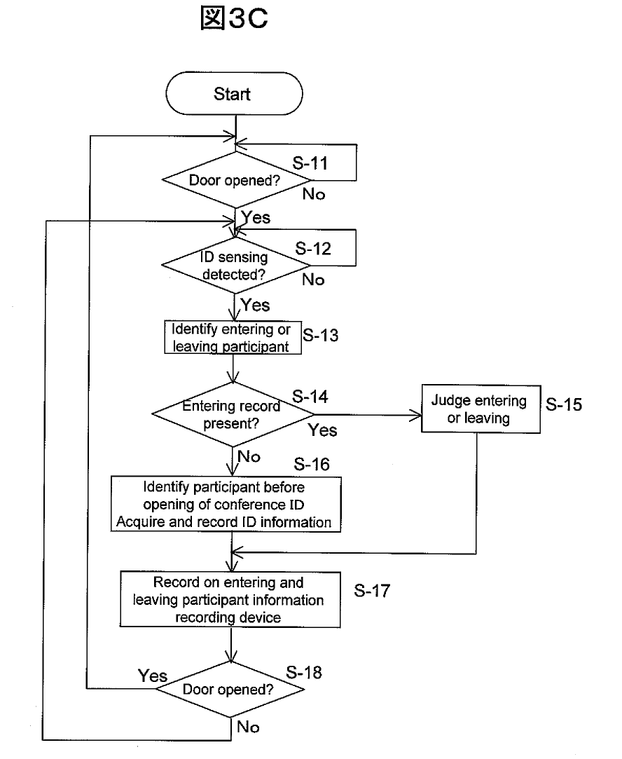

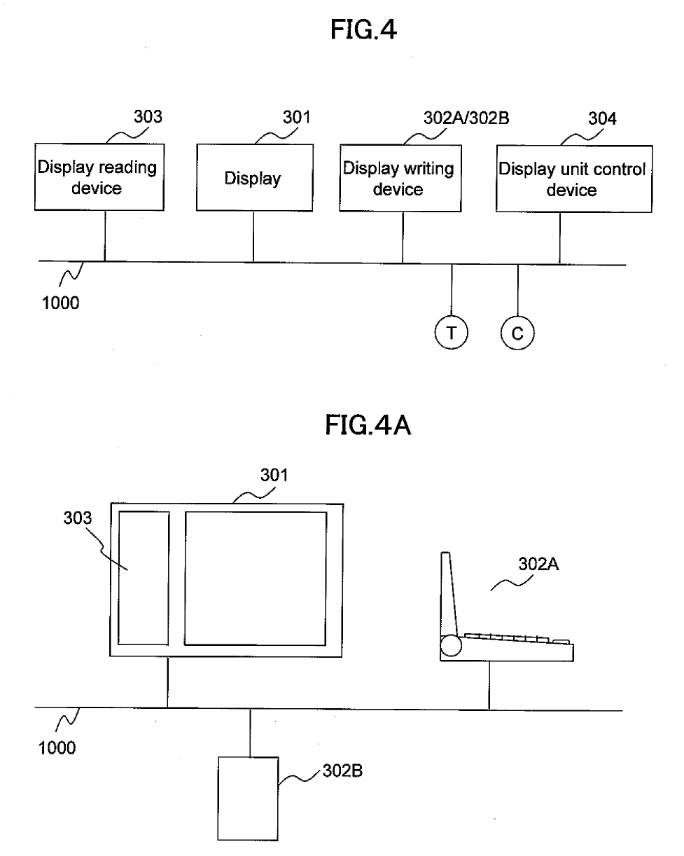

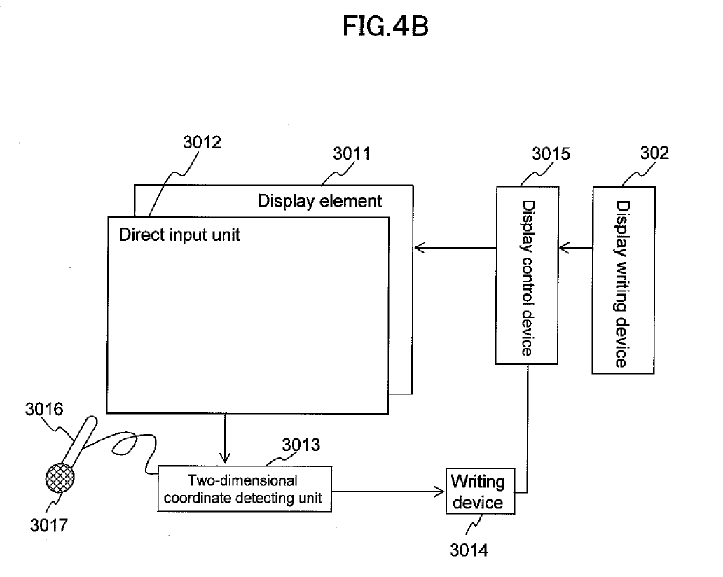

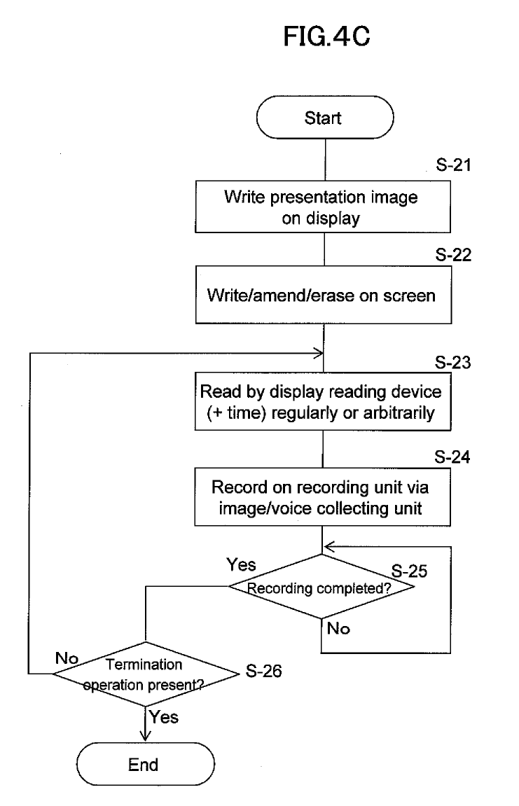

FIG. 4 is a functional block diagram to explain an arrangement example of the display unit 300 in FIG. 2. The display unit 300 of FIG. 1 comprises a display 300, a display writing device 302 (302A/302B), a display reading device 303, and a display unit control device 304. On the display 301, data such as documents, drawings, numerical formulae on the subject of the conference, display images for the proposal (presentation) in the opening of the conference, etc. are displayed. Also, the details of addition, amendment and deletion as added later to the displayed visible images are presented to all of the participants of the conference on this display 301. Special means is attached to this display to record together with the time information by regularly or arbitrarily reading the visible information as shown on the display screen as appropriate.

The display 301 adopted in the Embodiment 1 is a white board (or a projection screen), and the present system is a conference details recording system using the white board as display. As shown in FIG. 4A, the display 301 is provided with a display writing device 302 and a display reading device 303. The display writing device 302 has a writing operation device 302A and a projection device 302B. Typically, the writing operation device 302A is a personal computer, and the projection device 302B has an information source to display on the display 301 in addition to the function to perform display operation of the projection device 302B. The display reading device 303 belongs to a display 301, which is a white board. The presented image as given above is displayed by projecting it by means of the projecting device 302B, which is controlled by the operation device 302A on the display surface of the white board.

The display reading device 303 reads an image displayed by performing two-dimensional scanning over the display surface of the white board. This reading operation is carried out on the image information as displayed on the display screen regularly or arbitrarily at the predetermined time. The information thus read is recorded together with the time on the recording unit 500 of FIG. 1 under the control of the display unit control device by adding an identifier to indicate that it is the display contents of the display 301. It may be so arranged that a projection screen is installed separately from the white board as given above, and the screen contents displayed on the projection screen are given by the projecting device and the writing operation device (such as a personal computer), and the white board is used as writing means of a person, who explains, and these contents can be read by the display reading device. The image information displayed on the projection screen may be directly transferred from the writing operation device to the recording unit.

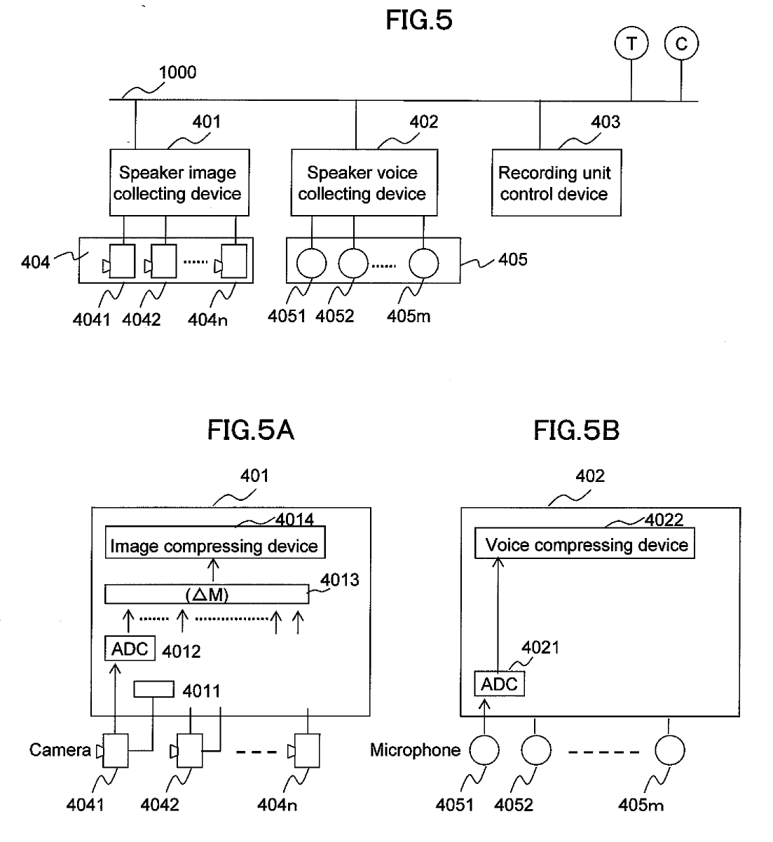

FIG. 5 is a functional block diagram to explain an arrangement example of the image/voice collecting unit 400. The image/voice collecting unit 400 comprises a speaker image collecting device 401, a speaker voice collecting device 402, and a recording unit control device 403. The speaker image collecting device 401 inputs an image pickup output signal of the image pickup device 404, which has the cameras 4041-404n. The speaker voice collecting device 402 inputs a collected voice output signal of the voice pickup device 405, which has the microphones 4051-405m.

As shown in FIG. 5A, the speaker image collecting device 401 collects image information as taken by the cameras 4041-404n and performs processing on this. For instance, image pickup output signal of the camera 4041 is given via an analog-digital converter (ADC) 4012 and is inputted to a moving detection device 4013. The moving (behavior) detecting device 4013 extracts the difference between frames as a valid image signal. This moving detection device 4013 is provided because it is wanted to eliminate the recording data amount, and this may not be needed when compression ratio of the image compression device 4014 of the subsequent stage is sufficiently high. The compressed image signal is recorded on the recording unit 500.

FIG. 5B shows an arrangement example of the speaker voice collecting device 402. The speaker voice collecting device 402 sends voice output signal of the microphones 4051-405m via ADC 4021 and compresses it at the voice compression device 4022, and the compressed voice signal is recorded on the recording unit 500. These operations are carried out by the recording unit control device 403.

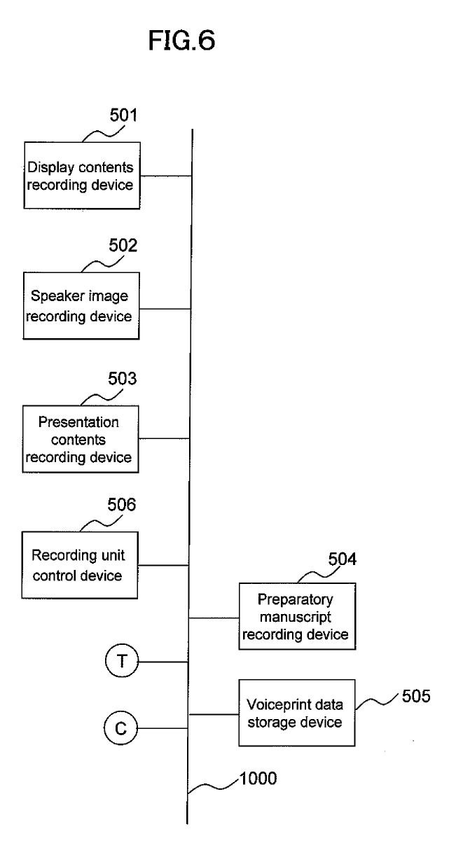

An arrangement example of the recording unit 500 is shown in FIG. 6. The recording unit 500 comprises a display contents recording device 501 for recording information displayed on the display 301, a speaker image recording device 502 for recording image information of the speaker collected at the speaker image collecting device 401, a presentation contents recording device 503 for recording voice information of the speaker collected at the speaker voice collecting device 402, a preparatory manuscript contents recording device 504 for recording general outline of the subject of the conference in advance, a voiceprint data storage device 505 for recording voiceprint extracted from the voice of a conference participant as collected by ID detection, and a recording unit control device 506 for controlling operations of these devices.

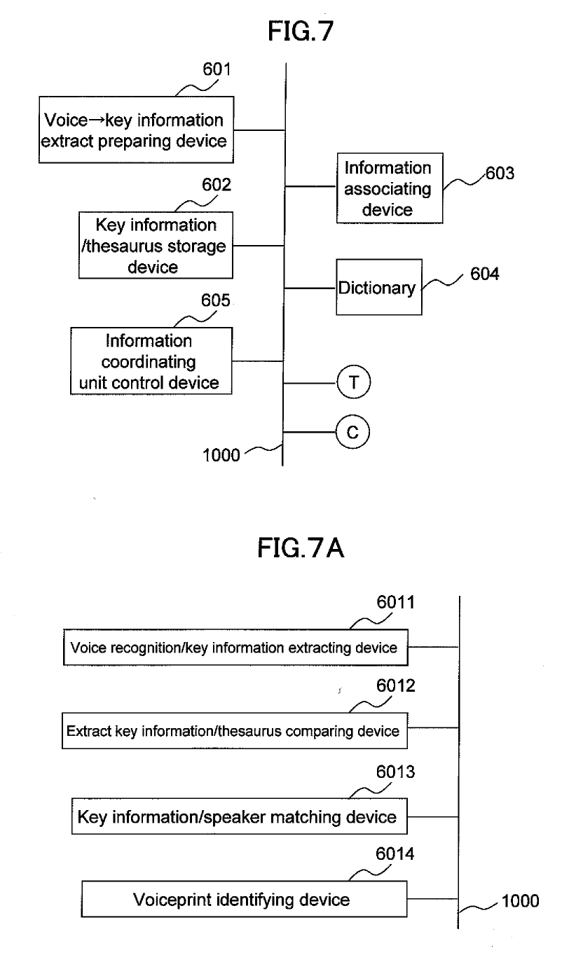

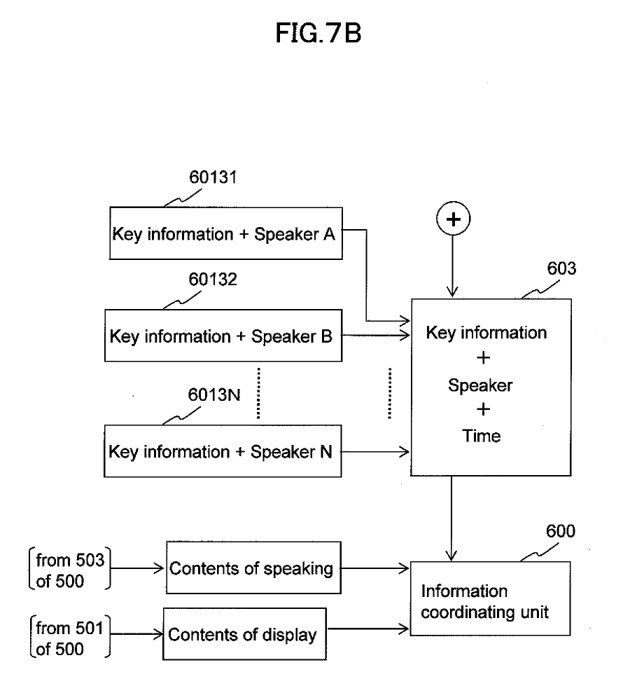

FIG. 7 is a functional block diagram to explain an arrangement example of an information coordinating unit 600 shown in FIG. 1. The information coordinating unit 600 is used to carry out information associating processing for recording various types of information such as voices and images during the course of the conference and displayed images with ID information of the participant and of the time. The information coordinating unit 600 comprises a voice→key information extract preparing device 601, a key information/thesaurus storage device 602, an information-associating device 603, a dictionary 604, and an information coordinating unit control device 605. The voice→key information extract preparing device 601 is used to extract the detailed contents stored in the dictionary 604 and the key information/thesaurus storage device 602, to extract idiomatic expressions, new words, technical terms, etc. of the related fields from the voice of the speakers by referring to the contents, and to associate the data with ID of each of the speakers at the information associating device 603. The key information thus obtained is used to update the recorded contents of the key information/thesaurus storage device 602 in order to integrate and consolidate the key information and thesaurus. As the dictionary 604, dictionaries in specialized technical fields are used in addition to general-purpose dictionaries, and these dictionaries are used in close relation with the key information and thesaurus.

FIG. 7A is a functional block diagram to explain an arrangement example of a voice-key information extracting device in the information coordinating unit 600. The voice recognition→key information extract preparing device 601 comprises a voice recognition/key information extracting device 6011, an extracted key information/thesaurus comparing device 6012, a key information/speaker associating device 6013, and a voiceprint identifying device 6014. The voice recognition/key information extracting device 6011 recognizes words, terms, and phrases from the voices collected by microphones, compares the results of the recognition with the key information stored in the key information/thesaurus storage device 602, registers the results currently existing as new types of key information, and associates the key information with each of the speakers by means of the information=associating device 603 and the key information/speaker matching device 6013.

FIG. 7B is a drawing to explain a processing example of the information associating device 603 in the information coordinating unit 600. At the information associating device 603, “key information+speaker A” 60131, “key information+speaker B” 60132, . . . “key information+speaker N” 6013N as prepared by the key information/speaker associating device 6013 are inputted to the information associating device 603. The information associating device 603 adds time information obtained from the clock to the “key information+speaker” data, and the result is transferred to the information coordinating unit 600.

In the information coordinating unit 600, the contents of presentation by each of the speakers from the presentation contents recording device 503 are inputted and the contents of display from the display contents recording device 501 are inputted. At the information coordinating unit 600, these inputted data are coordinated by using time, speaker, word, phrase, etc. as keys. The information thus coordinated is recorded on the recording unit 500 together with the time of the presentation of each type of information. It is needless to say that the recording unit 500 has a plurality of recording regions—i.e. a region to record the coordinated information, a region to record original type of information picked up by cameras and microphones, a region to record intermediate processing information, and a region to record information generated at each of the units.

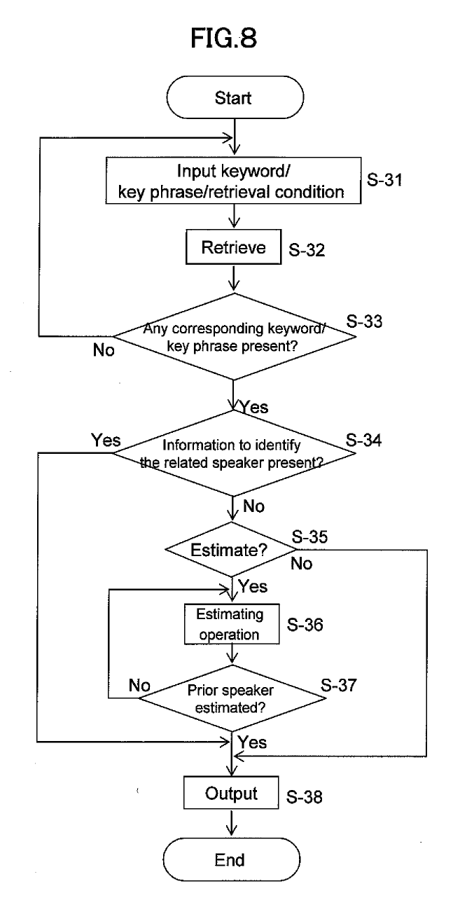

FIG. 8 is a flowchart to explain an example of the procedure to retrieve conference information recorded on the recording unit 500. The operation to retrieve the conference information is used to identify technical concept, concrete technical means, etc. proposed in the presentation, and in description, display, etc. presented during the course of the conference when the conference is terminated (hereinafter referred as “a certain presentation”). An input device 901 having a keyboard and a mouse used as an input/output interface 900 and a display monitor 902 for confirming keywords or key-phrases and condition of retrieval and for outputting the results are connected to superintendence control unit 700 shown in FIG. 1. Description will be given below on an input/output interface 900 using a key board and a mouse. FIG. 8 shows a flow of retrieval operation to identify a prior speaker of “a certain presentation” from the conference information recorded in the recording unit 500.

First, “a certain presentation” is inputted from the input/output interface 900 having keyboard and mouse as a keyword or a key phrase, which contains a plurality of words, together with the retrieval conditions such as the day when the conference was held, a code to identify the preparatory manuscript, etc. (S-31). Based on this keyword or key phrase and on the retrieval condition as given above, the retrieval of the recording unit is carried out (S-32). In case any keyword or key phrase is found in this retrieval operation (S-33), it is judged whether a type of information is present or not, which is useful to identify the name of the speaker associated with the keyword or the key phrase, or the information useful to identify the speaker (S-34). In case such information is present, the name of the speaker is outputted (S-38). The keyword or the key phrase inputted at the starting of the retrieval operation as given above or bibliographical data of the conference may be included in the output signal. By using keywords such as “to apply for patent”, “to apply for the right of intellectual property”, or “to file an application”, etc., it is possible to facilitate the judgment as to whether the application for the patent is proposed or not.

In case a keyword or a key phrase as appropriate is not found in the Step (S-33), it goes back to the Step (S-31), and the other retrieval condition is inputted again. In case the name of the speaker related to the keyword or the key phrase is not found in the Step (S-34), output signal of “not applicable” is issued (S-38), and it is selected whether the operation is to be terminated or the estimating operation is to be started (S-35). To make this selection, the button of “Yes” or “No” is displayed on the display monitor 902, and it is asked to the operator to select the button. When the operator presses the button “Yes” and selects to start the estimating operation, a pick-out retrieval operation using the related words is carried out (S-36).

The estimating operation is carried out repeatedly by a predetermined number of times, depending on the importance of the object to be retrieved, restriction in time, etc. (S-37). In case one or more prior speakers are estimated by this estimating operation, the result is outputted on the display monitor 902. Then, the data is printed out if necessary (S-38), and the procedure is terminated. The candidates of a plurality of the prior speakers as estimated are listed in the order from the one with higher probability to the lower. The probability for this estimation is calculated by probability theory by giving consideration on the frequency of speaking of a certain word, identification of the prior speakers and the subsequent speakers, and the contents of the questions given by the questioners.

By the conference details recording system with the arrangement in the embodiment as described above, it is possible to record various types of information presented during the course of the conference by associating with the speakers and the words and phrases used by the speakers, and these are recorded together with time information. Then, any type of information as desired can be easily reproduced from the recorded information by means of retrieval keys. As the keys to be used for the retrieval, the characteristics found in the image data and the voiceprint data may be used in addition to the words and the phrases.

### Embodiment 2

In the Embodiment 2, an electronic board, which can write, display, and read electronically, is used as the display unit 300 shown in FIG. 1. The arrangement and the operation other than those of the display unit 300 are the same as those shown in the Embodiment 1, and description is given here only on writing, display and reading as well as recording of image information displayed on the display unit 300. This electronic board is an electronic display device, which can directly write the data on screen. FIG. 4B shows an arrangement example of this display device. In FIG. 4B, the display device comprises a display element 3011 and a direct input unit 3012. As the display element 3011, a display panel is used, which can control display and non-display for each pixel on liquid crystal panel, plasma panel or organic EL (electroluminescence) panel, etc. The direct input unit 3012 is installed by superimposing it on the screen of this display element 3011.

The direct input unit 3012 is a two-dimensional coordinate detecting device. As the two-dimensional coordinate detecting device, a coordinate detecting device of known type such as optical type, electrostatic type, electric resistance type, etc. may be used. Also, a display panel with a position sensor on pixels may be used. In case of the display panel with position sensor on pixels, image is displayed on screen, and the image can be added, amended, or deleted. It can be understood as a device where the display element 3011 and the direct input unit 3012 of FIG. 4B are integrated together.

In FIG. 4B, an image is displayed on the display element 3011 by a display control device 3015 on the display writing device 302. To the image thus displayed, the image on the screen can be added, amended, or deleted directly by using a pen-like input implement 3016 on the displayed image. In this embodiment, an eraser 3017 is provided as a part of the input implement 3016, while an implement with erasing function (i.e. an eraser) may be provided separately. The contents thus erased may be stored on background.

The results of the addition and the amendment by the input implement 3016 and the results of erasing of the displayed portion by the eraser are detected by the two-dimensional coordinate detecting unit 3013, and the results are displayed on the screen of the display element 3011 via the display control device 3015 by using the addition, amendment, and erasing writing device 3014.

FIG. 4C is a flowchart to explain the operation to record information on a display screen where display, addition, erasing and correction can be made by using the electronic board shown in FIG. 4B, and the results are recorded on the recording unit. First, a presentation image is displayed on the display element 3011 (S-21). The speaker (the presenter) gives explanation on the image displayed and performs writing, amendment, erasing, etc. on the direct input unit 3012 as necessary. More concretely, these operations include the operations to draw underlines, to put a circular mark, to depict a picture for explanation, etc. on the portions as required of the displayed image to cope with the explanation. During this process, characters and pictures entered for amending the erroneous entry are erased (S-22). The types of information about the writing, the amendment, the erasing, etc., which have been directly inputted, are read by the display reading device 303 (S-23).

The reading operation is carried out together with the time information. The timing of the reading will be set as appropriate regularly with a predetermined time interval or at free will of the speaker. In case there is no moving on the screen during a predetermined time period, reading is not performed. At the moment when a change is noted or after the elapse of a certain time period from such moment, reading is carried out. Or, reading is performed as appropriate at the will of the speaker when writing, amendment, erasing, etc. are added to the screen.

It is desirable that this reading mode can be freely selected or can be carried out through combination with the timing. The image information thus read is recorded on the recording unit via the image/voice collecting unit (S-24). When this recording operation is terminated (S-24), and the presentations and the discussions are continued during the course of the conference (S-25), the procedures of (S-22) to (S-24) are repeatedly carried out. When the conference is closed (S-26), this processing is terminated.

According to the Embodiment 2, various types of information given during the course of the conference can be recorded together with the time information in association with each of the speakers, and with their words and phrases, and any type of information as desired can be easily reproduced from the recorded information by using a predetermined retrieval key, or the prior speaker can be identified or estimated.

1. A conference details recording system for recording various types of information presented during the course of a conference to be held in a conference room, and said system being capable to pick up a type of information as desired from the recorded information, wherein said system comprises:
an entering and leaving control unit to control entering and leaving of conference participants, and being installed at an entrance and an exit of said conference room, said system further comprises a display unit installed inside said conference room, an image/voice collecting unit, a recording unit, an information coordinating unit, a superintendence control unit, and a clock to output time information;
said entering and leaving control unit comprises an entering and leaving detection device, an entering and leaving attendant information recording device, an attendant registering device, an attendant ID information storage device, and an entering and leaving control unit control device;
said image/voice collecting unit comprises a speaker image collecting device for inputting an image pickup output signal from the image pickup device having a plurality of cameras, and a speaker voice collecting device for inputting voice output signal of the voice pickup device having a plurality of microphones;
said recording unit comprises a display contents recording device for recording visible information shown on said display, a speaker image recording device for recording an image information of the speaker picked up by said speaker image collecting device, a presentation contents recording device for recording voice information of the speaker picked up by the speaker voice collecting device, a preparatory manuscript contents recording device for recording general outline of the subject of the conference in advance, and a voiceprint data storage device for recovering voiceprint extracted from the voice of each of conference participants as picked up through the matching of ID detection;
said information coordinating unit comprises a voice→key information extract preparing device, a key information/thesaurus storage device, an information associating device, a dictionary, and an information coordinating unit control device;
said superintendence control unit has an input/output interface for inputting retrieval conditions at the starting of the system, for advance setting such as bibliographic matters necessary prior to the opening of the conference, for the setting of basic control conditions, and in the information retrieval mode; and
said system used for retrieving a type of-information recorded on said recording unit on another day by using key information inputted from the input/output interface of said superintendence control unit, such that;
said system used for retrieving a prior speaker or a presenter by key information of specific word(s) or phrase(s) with or without time passing of said, and for retrieving specific word(s) or phrase(s) by key information of a specific speaker or a presenter with or without time passing of said conference.

2. A conference details recording system according to claim 1, wherein:
said entering and leaving control unit comprises an entering and leaving detection device, an entering and leaving attendant information recording device, an participant registering device, a voice analyzing device, an participant ID information storage device, and an entering and leaving control unit control device;
said entering and leaving detection device comprises an ID card reading device for reading information stored in an ID card where an IC chip is embedded and carried by a conference participant who is entering the conference room, cameras for picking up figures and features of the conference participants, and microphones for picking up voices of the conference participants; and
said system is used to detect personal information of each of the conference participants wishing to enter the conference room and detects conference participants entering or leaving the conference room thereafter.

3. A conference details recording system according to claim 2, wherein:
said entering and leaving detection device has a bio-interface for carrying out biometrical authentication of each conference participant instead of said ID card reading device or in addition to said ID card reading device.

4. A conference details recording system according to claim 1, wherein:
said display unit comprises a display capable to carry out addition, amendment or deletion directly on the screen to a visible image display for visibly displaying information relating to the subject of the conference, a display writing device for writing information on said display, and a display reading device for reading information displayed on screen.

5. A conference details recording system according to claim 1, wherein:
said display unit comprises a display element for controlling display and non-display for each pixel, and a direct input unit superimposed on a screen of said display element.
